(19) United States
(12) Patent Application Publication
(10) Pub. No.: US 2026/0183910 A1
(43) Pub. Date: Jul. 2, 2026

(54) APPARATUS FOR CONNECTING REINFORCEMENT

(71) Applicant: Illinois Tool Works Inc., Glenview, IL (US)

(72) Inventor: James Stone, Glenview, IL (US)

(21) Appl. No.: 19/131,457

(22) PCT Filed: Nov. 21, 2023
(86) PCT No.: PCT/US2023/080706

§ 371 Date: May 20, 2025

(30) Foreign Application Priority Data
Nov. 22, 2022 (AU) 2022903540

(51) Int. Cl. B25B 27/00; B25B 21/00; E04G 21/12

(52) U.S. Cl. CPC B25B 27/0014; B25B 21/002; E04G 21/122

(57) ABSTRACT

An apparatus for connecting reinforcing bar to a threaded fitting, the apparatus including a base, a holder for holding the reinforcing bar against rotation relative to the base, and a support for a driving tool for threadedly driving the threaded fitting onto an end portion of the reinforcing bar, wherein the apparatus includes a brace for bracing the support against movement relative to the base.

### PRIORITY CLAIM

This application is a national stage application of PCT/US 2023/080706, filed on Nov. 21, 2023, which claims priority to and the benefit of Australian Application No. 2022903540, which was filed on Nov. 22, 2022, the entire contents of each of which are incorporated herein by reference.

### FIELD

The present disclosure relates to an apparatus for connecting reinforcement. More particularly, but not exclusively, the present disclosure relates to an apparatus for connecting reinforcing bar with a threaded coupler. The coupler may be in the form of a threaded connecting device for threaded reinforcing bar to form a mechanical connection as may be used in concrete construction.

### BACKGROUND

One form of reinforcing bar used in concrete construction incorporates a continuous coarse external thread. The thread not only acts to form a key between the bar and concrete, it also enables a range of supplementary fittings easily to be applied to the bar by engagement of a mating thread with that of the bar. One such threaded reinforcing bar is marketed under the trademark “ReidBar” by Reid Construction Systems, a division of ITW Australia Pty Ltd, a related entity of the present applicant. The thread on the reinforcing bar is quite coarse and its pitch ranges from 8 mm for a bar of 12 mm diameter to around 16.5 mm for a bar diameter of 32 mm.

Internally threaded fittings for mounting over the end of threaded reinforcing bar for example for coupling lengths of bar in series tend, principally for cost considerations, to be of cast construction, with the internal thread being formed during casting by a sand core. The internal thread formed in this way is not formed to the degree of accuracy which would be expected from a conventionally tapped thread and, moreover, the external thread on the bar itself is not formed to a particularly high degree of accuracy. A consequence of this is that there may not be a particularly tight engagement between the fitting and the bar and some longitudinal movement or free-play can occur between the bar and the fitting.

Longitudinal free-play of a coupler on a threaded reinforcing bar can have serious consequences and relevant construction standards require that slip be limited and controlled. This can be difficult to achieve given the large tolerances involved in manufacturing coarse threaded bar. While slippage can be avoided by filling the interior of the coupler with an epoxy cement or by mounting a lock nut on the bar to tighten against the end of the coupler, these measures add to the time and cost of installing the coupler to the bar as well as not being accepted as solutions by certain construction authorities. Other methods include machining metric threads and swaging sleeves onto the ends of the bar. These are even more time-consuming, complex and expensive due to the extra processes and equipment required. Accordingly, it is desirable to provide a coupler that can accommodate the loose tolerances of the reinforcing bar and minimise slip of the coupler along the reinforcing bar to within the required standard.

The applicant has also determined that existing methods and devices do not permit installation in some circumstances where rotation of the reinforcing bars is not possible and/or where a gap has to be bridged between the two elements. It has been determined that it would be advantageous for there to be provided a coupler which enables coupling between reinforcing bars where rotation of the reinforcing bars is prevented or at least restricted, and which provides bridging of a gap between the reinforcing bars to be coupled. The applicant has further determined that it would be advantageous to provide an improved coupler for mechanically coupling reinforcing bars and to provide an apparatus for mechanically coupling the coupler to a reinforcing bar.

### SUMMARY

In accordance with one aspect of the present disclosure, there is provided an apparatus for connecting reinforcing bar to a threaded fitting, the apparatus including a base, a holder for holding the reinforcing bar against rotation relative to the base, and a support for a driving tool for threadedly driving the threaded fitting onto an end portion of the reinforcing bar, wherein the apparatus includes a brace for bracing the support against movement relative to the base.

Preferably, the brace is arranged for bracing the support against rotation relative to said base during operation of the driving tool whereby torque is used for securing the threaded fitting to the reinforcing bar.

In a preferred form, a predetermined torque threshold is used for securing the threaded fitting to the reinforcing bar and the brace is arranged for bracing the support against rotation relative to said base during operation of the driving tool at said torque threshold.

In one form, the driving tool includes a torque multiplier. More preferably, the driving tool includes a torque multiplier in combination with a motor-driven rotational driver.

Preferably, the reinforcement bar is for reinforcing concrete and is often referred to herein as a reinforcing bar.

Preferably, the reinforcement bar is externally threaded. More preferably, the threaded fitting is internally threaded corresponding to an external thread of the reinforcement bar. Even more preferably, the threaded fitting has an internal stop for abutment against an end of the reinforcing bar.

The predetermined torque threshold may be used to achieve a specified slip threshold between the threaded fitting and the reinforcing bar.

Preferably, the brace has a plurality of bracing parts for bracing the support against movement relative to the base. More preferably, the brace has a pair of opposed bracing parts for bracing the support against movement relative to the base. Even more preferably, each of the bracing parts extends substantially perpendicular to an axis of the reinforcing bar.

Preferably, the support is arranged to be slidable relative to the base in a direction parallel to an axis of the reinforcing bar. More preferably, the base includes a pair of rails along which the support is slidable.

It is preferred that the reinforcing bar has opposed flat surfaces and the holder is arranged to engage with said flat surfaces to hold the reinforcing bar against rotation relative to the base.

Preferably, the holder includes a pair of clamp halves. More preferably, each of the clamp halves has an internal threadform corresponding to external thread of the reinforcing bar. Even more preferably, the clamp halves are interchangeable to accommodate reinforcing bars of different sizes.

The clamp halves may be hingedly movable between an open condition, in which the reinforcing bar is able to be inserted or removed, and a closed condition, in which the reinforcing bar is held between the clamp halves.

Preferably, the holder includes a biased clip for locking the clamp halves in the closed condition. More preferably, the holder includes a latch with spring mechanism having an over centre design, so that the latch is able to selectively move the biased clip between an operable configuration and a non-operable configuration. Even more preferably, the apparatus includes at least one tightening member for increasing clamping force of the holder on the reinforcing bar.

In one form, the base is anchored to a structure.

In accordance with another aspect of the present disclosure, there is provided a method of connecting a threaded fitting to a reinforcing bar, including the steps of:
providing an apparatus including a base, a holder and a support;
placing the reinforcing bar in the holder for holding the reinforcing bar against rotation relative to the base;
using the support to support a driving tool against movement relative to the base; and
using the driving tool to apply torque to the threaded fitting over an end of the reinforcing bar to a threshold torque to secure the threaded fitting to the reinforcing bar.

Preferably, the method further includes the step of removing the reinforcing bar, with the threaded fitting connected, from the holder.

### BRIEF DESCRIPTION OF THE DRAWINGS

The present disclosure is further described by way of non-limiting example only with reference to the accompanying drawings, in which:

FIG. 1 shows an upper perspective view of an apparatus for connecting a threaded fitting to reinforcement bar in accordance with an example of the present disclosure;

FIG. 2 shows a side view of the apparatus;

FIG. 3 shows an end view of the apparatus;

FIG. 4 shows a side perspective view of a holder of the apparatus in an open condition, showing detail of an upper half clamping portion;

FIG. 5 shows an upper perspective view of the holder in the open condition, showing detail of a lower half clamping portion;

FIG. 6 shows a rear perspective view of a support of the apparatus with a driving tool mounted therein;

FIG. 7 shows a front perspective view of the driving tool mounted in the support of the apparatus;

FIG. 8 shows an upper perspective view of the holder shown in a closed condition;

FIG. 9 shows an upper perspective view of the holder shown in an open condition;

FIG. 10 shows an end perspective view of the holder shown in the closed condition, with detail of a latch and spring mechanism having an over centre arrangement;

FIG. 11 shows an end view of the latch shown in an operational configuration;

FIG. 12 shows an end view of the latch shown in a non-operational configuration;

FIG. 13 shows an upper perspective view of the holder of the apparatus shown in the closed condition, with upper detail of a screw threaded fastener for applying a clamping force;

FIG. 14 shows an upper perspective view of the holder of the apparatus shown in the closed condition, with a screw and Cam action quick release to apply clamping force; and

FIG. 15 shows an upper perspective view of the apparatus in combination with a reinforcing bar and threaded fitting, prior to insertion of the reinforcing bar into the holder.

### DETAILED DESCRIPTION

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

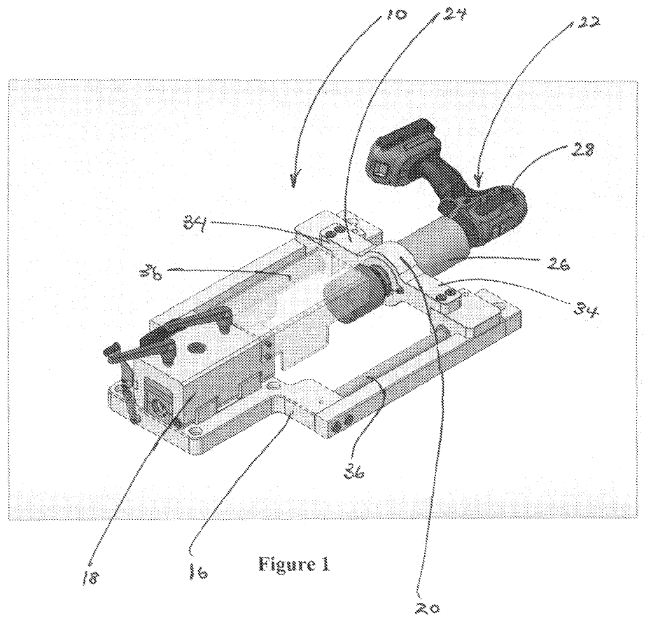

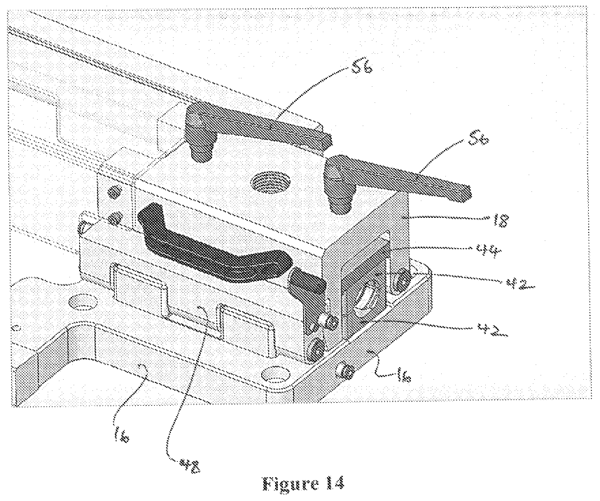

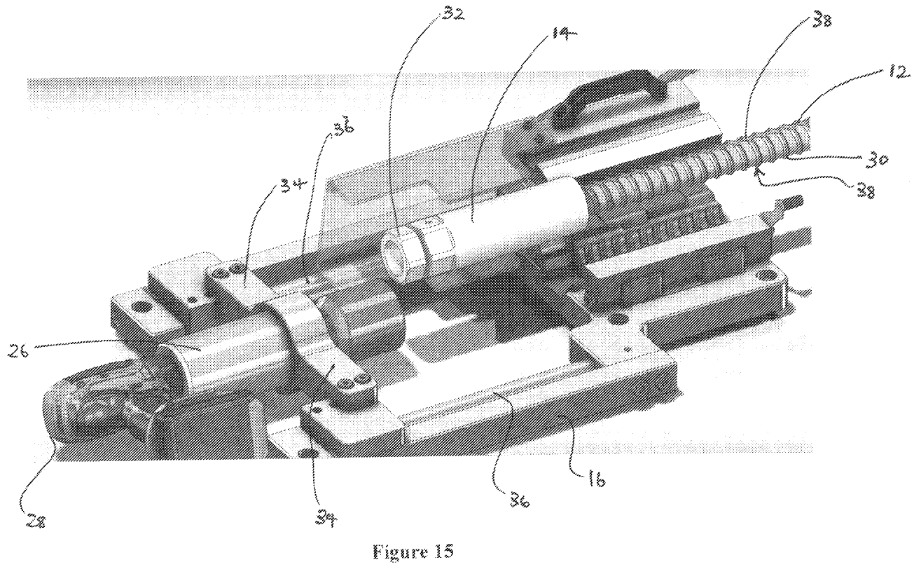

As can be seen in FIGS. 1 to 15 of the drawings, there is provided an apparatus 10 for connecting reinforcing bar 12 (see FIG. 15) to a threaded fitting 14. The apparatus 10 includes a base 16, a holder 18 for holding the reinforcing bar 12 against rotation relative to the base 16, and a support 20 for a driving tool 22 for threadedly driving the threaded fitting 14 onto an end portion of the reinforcing bar 12. The apparatus 10 includes a brace 24 for bracing the support 20 against movement relative to the base 16. The holder 18 acts as an anti-rotational system for restraining against rotation of the reinforcing bar 12 as the threaded fitting 14 is threaded onto the reinforcing bar 12.

Advantageously, the apparatus 10 facilitates connection of the threaded fitting 14 to the reinforcing bar 12 without modification of the reinforcing bar 12 (for example, modification by machining the reinforcing bar 12 to have a metric thread). Also advantageous is that the apparatus 10 may be portable.

The brace 24 is arranged for bracing the support 20 against rotation relative to the base 16 during operation of the driving tool 22 whereby torque is used for securing the threaded fitting 14 to the reinforcing bar 12.

In the example shown in the drawings, a predetermined torque threshold is used for securing the threaded fitting 14 to the reinforcing bar 12 and the brace 24 is arranged for bracing the support 20 against rotation relative to the base 16 during operation of the driving tool 22 at the torque threshold. The torque threshold may be relatively high, possibly in the region of 1500 Nm (by way of example only).

With reference to FIG. 1, the driving tool 22 may include a torque multiplier 26. In particular, as shown, the driving tool 22 may include a torque multiplier 26 in combination with a motor-driven rotational driver 28. The applicant has determined that this form of driving tool 22 may be beneficial through achieving consistent torque, as opposed to an impact driver which the applicant has determined to have inconsistent torque.

The reinforcing bar 12 may be of the kind used for reinforcing concrete and may be externally threaded, as shown in FIG. 15. The threaded fitting 14 may be internally threaded corresponding to an external thread 30 of the reinforcing bar 12. The threaded fitting 14 may have an internal stop for abutment against an end of the reinforcing bar 12, to facilitate application of a high torque by the apparatus 10 to the threaded fitting 14 upon the reinforcing bar 12 so as to achieve a desired secure fitment with minimal slip in accordance with a required specification. The threaded fitting 14 may also be provided with a frangible driving nut 32 to indicate to an operator when the desired torque threshold has been achieved. As an alternative to the frangible driving nut, the desired torque threshold may be achieved by way of a torque measuring tool.

The predetermined torque threshold may be used to achieve a specified slip threshold between the threaded fitting 14 and the reinforcing bar 12.

The brace 24 may have a plurality of bracing parts 34 for bracing the support 20 against movement relative to the base 16. In particular, the brace 24 may have a pair of opposed bracing parts 34 for bracing the support 20 against movement relative to the base 16. With reference to FIG. 15, each of the bracing parts 34 extends substantially perpendicularly to an axis of the reinforcing bar 12 so as to provide lever arms to prevent rotation, twisting and/or deflection of the support 20 relative to the base 16. The pair of bracing parts 34 act as opposite arms against a bending moment to assist in achieving the set torque and quality of installation. As the support 20 is on rails 36, this facilitates optimal axial location of the socket 44 for engagement with the threaded fitting 14. It will be appreciated by those skilled in the art that there may be alternatives to the driving tool 22 such as, for example, manual driving of the threaded fitting 14.

The support 20 is arranged to be slidable relative to the base 16 in a direction parallel to an axis of the reinforcing bar 12. In the example shown in FIG. 1, the base 16 includes a pair of rails 36 along which the support 20 is slidable.

As shown in FIG. 15, the reinforcing bar 12 has opposed flat surfaces 38 (top and bottom) and the holder 18 is arranged to engage with said flat surfaces 38 to hold the reinforcing bar 12 against rotation relative to the base 16.

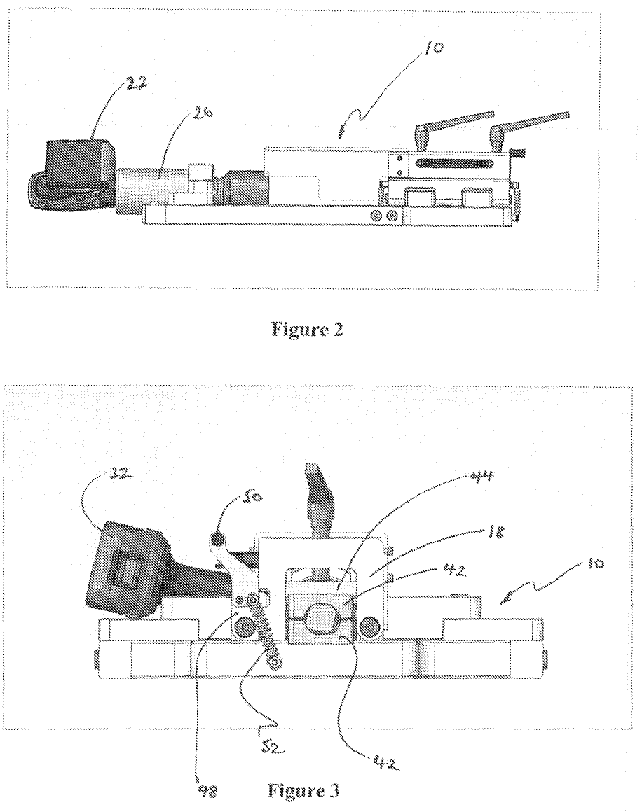

FIG. 2 shows a side view of the apparatus 10 and FIG. 3 shows an end view from an end of the apparatus at which the holder 18 is located. The driving tool 22 may be provided with a socket 44 engaging with the frangible driving nut 32 so as to apply torque to same.

With reference to FIGS. 3 to 5, in the example shown, the holder 18 includes a pair of clamp halves 42, and may also include a top plate 44 to facilitate application of clamping force. Each of the clamp halves 42 depicted has an internal threadform 46 corresponding to the external thread 30 of the reinforcing bar 12. The clamp halves 42 may be interchangeable with other clamp halves of different size/configuration to accommodate reinforcing bars of different sizes. As an alternative to the internal threadform 46, each of the clamp halves 42 may have a different formation, for example, to focus on engagement with specific areas of the reinforcing bar 12.

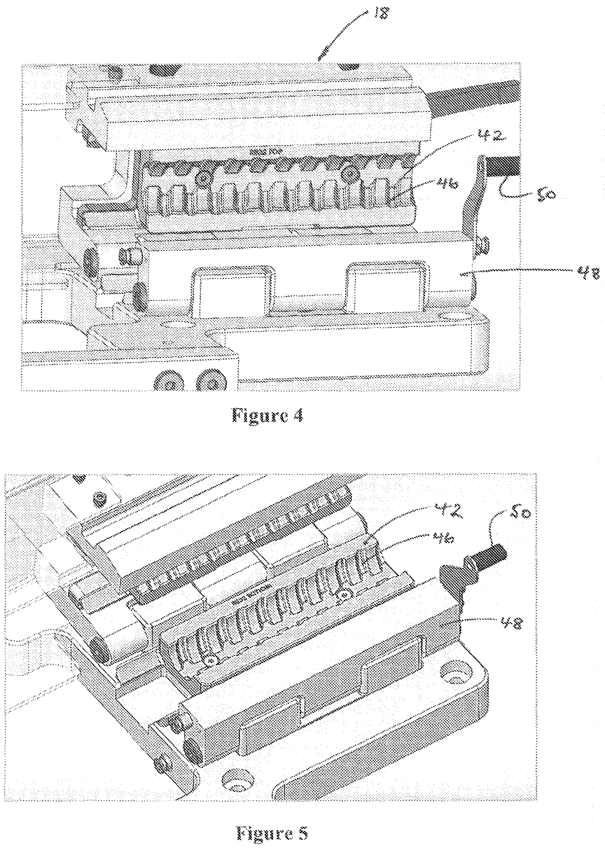

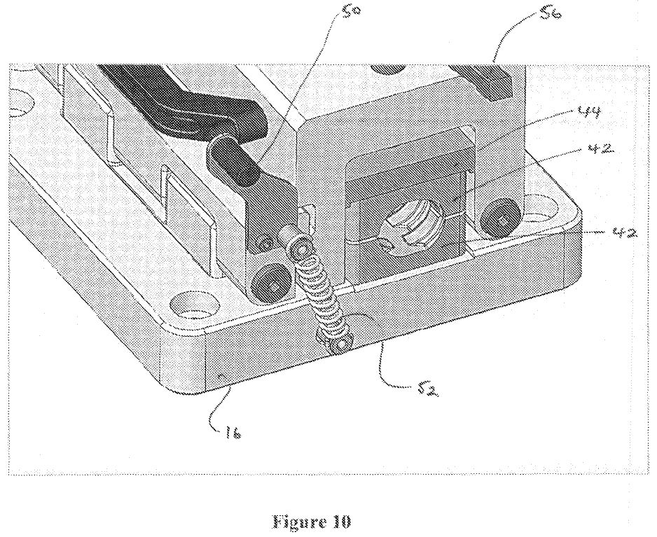

The clamp halves 42 may be hingedly movable between an open condition (as shown in FIGS. 4 and 5), in which the reinforcing bar 12 is able to be inserted or removed, and a closed condition (as shown in FIG. 10), in which the reinforcing bar 12 is able to be rotatably held between the clamp halves 42.

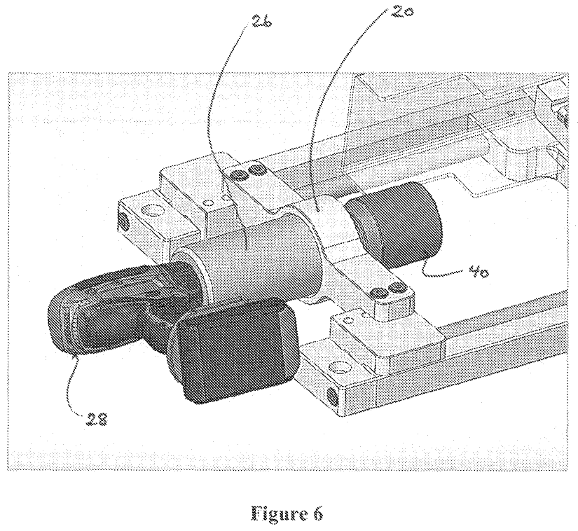

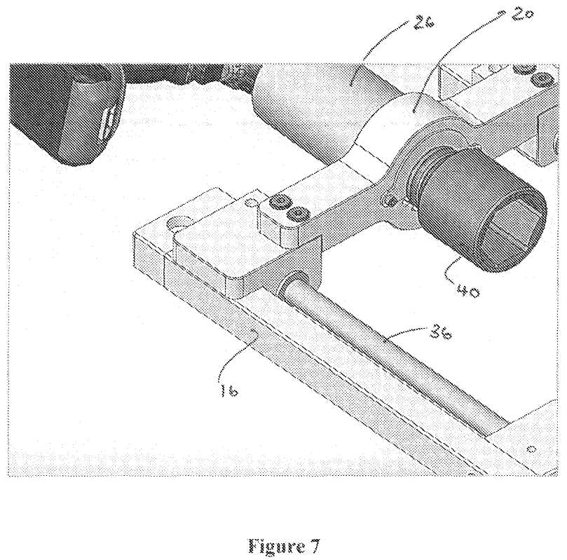

FIGS. 6 and 7 show detail of the driving tool 22 supported by the support 20. The support 20 may be provided with radial teeth, and the torque multiplier 26 may be provided with corresponding radial teeth so as to be held securely against rotation relative to the support 20.

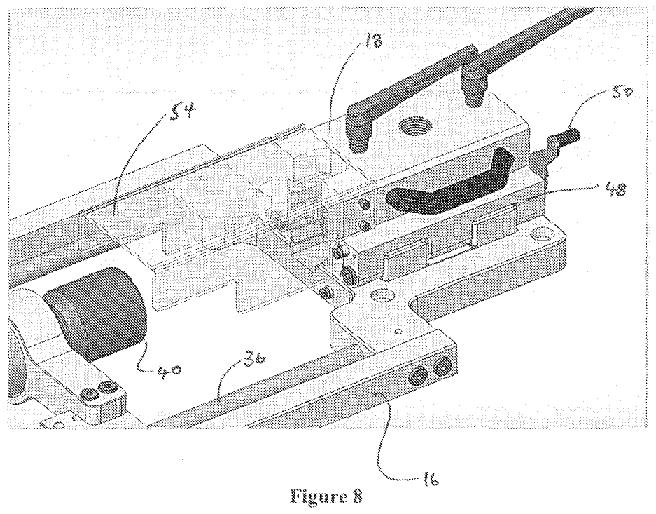

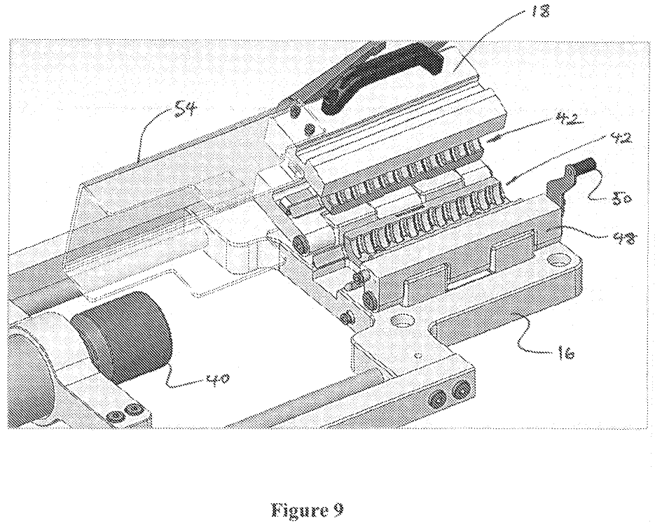

FIG. 8 shows the holder 18 in the closed condition and FIG. 9 shows the holder 18 in the open condition. A shield 54 may be provided as part of the apparatus 10 for safety, particularly in view of the high torque being applied, to protect the operator.

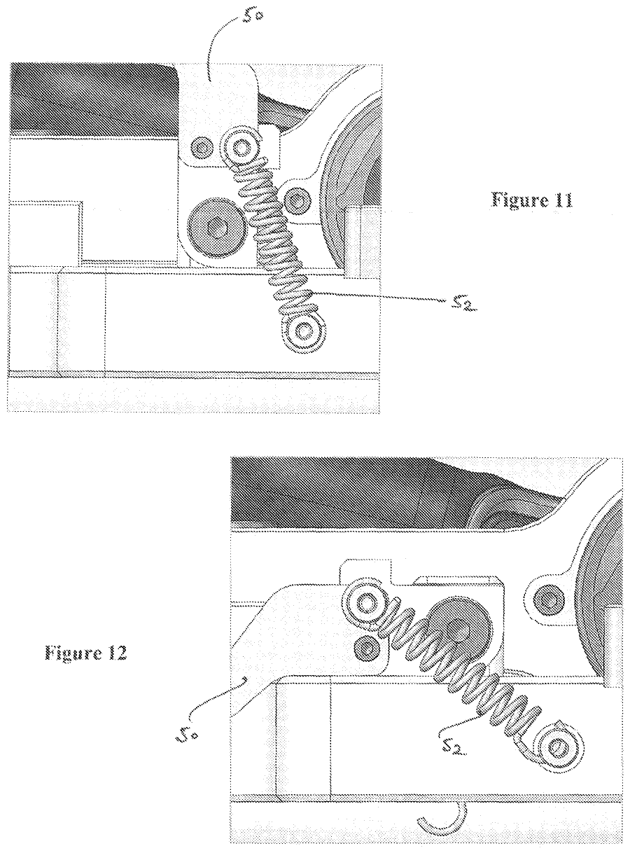

The holder 18 of the depicted example includes a biased clip 48 for locking the clamp halves 42 in the closed condition. More specifically, as shown in FIGS. 3 to 5, the holder 18 includes a latch 50 with spring 52 mechanism having an over centre design, so that the latch 50 is able to selectively move the biased clip 48 between an operable configuration (FIG. 11) and a non-operable configuration (FIG. 12). With reference to FIG. 10, the apparatus 10 may include at least one tightening member 56 for increasing clamping force of the holder 18 on the reinforcing bar 12. The tightening member 56 may be in the form of a screw and cam action quick release for applying clamping force and for locking the top plate 44 in place. Alternatively, hydraulic force may be used for acting on the top jaw through either an external hydraulic press or a fitted hydraulic cylinder. The base may be anchored securely to a structure, such as a bench for floor surface. In particular, the apparatus can be fixed to a bench or trolley through the six mounting holes located in the base 16.

As will be appreciated from the above, the present disclosure provides a method of connecting a threaded fitting 14 to a reinforcing bar 12, including the steps of:
providing an apparatus 10 including a base 16, a holder 18 and a support 20;
placing the reinforcing bar 12 in the holder 18 for holding the reinforcing bar 12 against rotation relative to the base 16;
using the support 20 to support a driving tool 22 against movement relative to the base 16; and
using the driving tool 22 to apply torque to the threaded fitting 14 over an end of the reinforcing bar 12 to a threshold torque to secure the threaded fitting 14 to the reinforcing bar 12.

The method may further include the step of removing the reinforcing bar 12, with the threaded fitting 14 connected, from the holder 18.

Accordingly, as will be appreciated from the above, the applicant has developed a vice or holding fixture for a new coupling system to join reinforcement bars within concrete structures, allowing continuous reinforcement between concrete elements.

The coupling system relies on screen together each coupler half onto the reinforcing bar and applying a set torque to ensure the performance of the system. To aid the installation and ensure that the reinforcing bar is held firmly and safely when the torque is applied, the applicant has developed a vice/fixture to assist operators with this procedure.

The core function of the product is to firmly hold the reinforcing bar (which may be in the form of externally threaded reinforcing bar marketed under the branding ReidBar) when torque is applied via a coupler or fitting being screwed on to the reinforcing bar. This ensures when the torque is applied, force is not lost through the relative movement of the reinforcing bar and/or the bar rotates suddenly creating an unsafe condition when installing the coupler or fitting.

Other key functions of the product include:
accommodating all sizes of reinforcing bar such as RB12, RBA16, RB20, RBA20, RB25, and RB32;
being configured for use with a torque multiplier, includes support for the torque multiplier;
providing that a clamping load can be applied via an incorporated mechanical method or additional hydraulic or pneumatic unit; and
providing a system that is modular and can incorporate elements to automate parts of the process or all of the process.

To help the Vice/Fixture perform the functions outlined, it incorporates a number of unique features including:
reinforcing bar thread detail in vice/fixture to securely hold reinforcing bar. Detail holds the minor diameter, major diameter and across the flats of the reinforcing bar to ensure a firm hold when clamped. Detail may also just hold on the flats and the major diameter.
being able to hold all sizes of reinforcing bar such as RB12, RBA16, RB20, RBA20, RB25, and RB32.
being configured to utilize interchangeable jaws to hold specific reinforcing bar size.
having jaw features specific to reinforcing bar profile to securely hold reinforcing bar;
providing support for powered torque multiplier through different slide fixtures;
providing support for manual torque multiplier through different slide fixtures;
providing support mounted on ‘rails’ to allow the torque multiplier to move in and away from coupler being tightened while also taking the torque multiplier reaction force. Allows sufficient torque to be applied to break shear nut on coupler to indicate correct tightening torque. Reduces operator fatigue and improves safety;
including detail to indicated correct positioning of bar within vice/fixture;
providing a flip open configuration that enables quick install and removal of reinforcing bar in the vice;
providing a quick release spring loaded latch 50 allows quick securing of the top piece of the vice fixture; and
providing a latch 50 and spring 52 mechanism feature over centre configured to allow the latch to be quickly released for removal of the finished bar assembly.

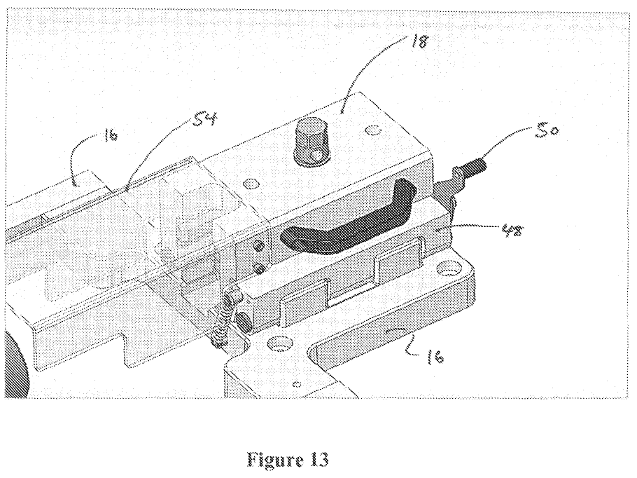

With reference to FIG. 13, the apparatus 10 provides a mechanical method to apply the clamping force to the vice by either one or a combination of the following:
Screw thread, preferably trapezoidal screw thread acting on the top plate and top jaw;
Threaded lever clamps acting on the top plate and top jaw;
Screw and cam action quick release to apply clamping force and lock top plate in place; and
Hydraulic force acting on the top jaw through either an external hydraulic press or a fitted hydraulic cylinder.

The example of the present disclosure shown in the drawings also provides a method of assembly using the fixture, as follows:
1. Cut corresponding reinforcing bar to be joined square;
2. Hand thread coupler half onto reinforcing bar until it bottoms in the base of the coupler;
3. Ensure correct size jaws and socket are fitted for the corresponding reinforcing bar being used;
4. Fit reinforcing bar and coupler into vice/fixture;
5. Close top of vice and ensure latch has secured;
6. Wind each lever clamp or screw thread down to apply force on the top jaw of the vice;
7. Move torque multiplier and socket on to coupler and apply torque until shear nut is removed;
8. Move torque multiplier and socket away from coupler assembly;
9. Unwind each lever clamp or screw thread to release compression on reinforcing bar;
10. Open latch to release the top piece of the vice; and
11. Open vice and remove coupler bar assembly.

While various embodiments of the present disclosure have been described above, it should be understood that they have been presented by way of example only, and not by way of limitation. It will be apparent to a person skilled in the relevant art that various changes in form and detail can be made therein without departing from the spirit and scope of the present disclosure. Thus, the present disclosure should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### LIST OF FEATURES

10 Apparatus
12 Reinforcing bar
14 Threaded fitting
16 Base
18 Holder
20 Support
22 Driving tool
24 Brace
26 Torque multiplier
28 Motor-driven rotational driver
30 External thread
32 Frangible driving nut
34 Bracing parts
36 Rails
38 Opposed flat surfaces
40 Socket
42 Clamp halves
44 Top plate
46 Internal threadform
48 Biased clip
50 Latch
52 Spring
54 Shield
56 Tightening member

1-26. (canceled)

27. An apparatus for connecting a threaded fitting to an end portion of a reinforcing bar, the apparatus comprising:
a base;
a holder connected to the base and positioned to receive and hold the reinforcing bar against rotation relative to the base;
a support connected to the base and positioned to be engaged by a driving tool that can threadedly drive the threaded fitting onto the end portion of the reinforcing bar; and
a brace connected to the base and positioned to prevent movement of the support relative to the base.

28. The apparatus of claim 27, wherein the brace is positioned to prevent rotation of the support relative to the base when the driving tool applies rotational torque to secure the threaded fitting to the end portion of the reinforcing bar.

29. The apparatus of claim 27, wherein a predetermined torque threshold is usable to secure the threaded fitting to the reinforcing bar and the brace is configured to brace the support against rotation relative to the base during operation of the driving tool at the predetermined torque threshold.

30. The apparatus of claim 27, wherein the driving tool includes a torque multiplier.

31. The apparatus of claim 30, wherein the driving tool includes a torque multiplier in combination with a motor-driven rotational driver.

32. The apparatus of claim 27, wherein the reinforcing bar is a concrete reinforcing bar.

33. The apparatus of claim 27, wherein the reinforcing bar has external thread form.

34. The apparatus of claim 33, wherein the threaded fitting is internally threaded to correspond to the external thread form of the reinforcing bar.

35. The apparatus of claim 34, wherein the threaded fitting has an internal stop positioned to abut against an end of the reinforcing bar.

36. The apparatus of claim 29, wherein the predetermined torque threshold is usable to achieve a specified slip threshold between the threaded fitting and the reinforcing bar.

37. The apparatus of claim 27, wherein the brace includes a plurality of bracing parts that brace the support against movement relative to the base.

38. The apparatus of claim 37, wherein the brace includes a pair of opposed bracing parts that brace the support against movement relative to the base.

39. The apparatus of claim 38, wherein each of the bracing parts extends substantially perpendicular to an axis of the reinforcing bar.

40. The apparatus of claim 27, wherein the support is slidable relative to the base in a direction parallel to an axis of the reinforcing bar.

41. The apparatus of claim 40, wherein the base includes a pair of rails that enable the support to be slidable.

42. The apparatus of claim 27, wherein the reinforcing bar includes opposed flat surfaces and the holder is positioned to engage with the flat surfaces to hold the reinforcing bar against rotation relative to the base.

43. The apparatus of claim 27, wherein the holder includes a pair of clamp halves that each has an internal threadform corresponding to external thread of the reinforcing bar.

44. The apparatus of claim 43, wherein the clamp halves are hingedly movable between an open condition in which the reinforcing bar is able to be inserted or removed, and a closed condition in which the reinforcing bar is held between the clamp halves.

45. The apparatus of claim 44, wherein the holder includes a biased clip that locks the clamp halves in the closed condition.

46. The apparatus of claim 45, wherein the holder includes a latch with a spring mechanism, the latch configured to selectively move the biased clip between an operable configuration and a non-operable configuration.
